(19) United States
(12) Patent Application Publication
(10) Pub. No.: US 2018/0186452 A1
(43) Pub. Date: Jul. 5, 2018

(54) Unmanned Aerial Vehicle Interactive Apparatus and Method Based on Deep Learning Posture Estimation

(71) Applicant: Beijing Deephi Technology Co., Ltd., Beijing (CN)

(72) Inventors: Lu Tian, Beijing (CN); Yi Shan, Beijing (CN); Song Yao, Beijing (CN)

(21) Appl. No.: 15/860,772

(22) Filed: Jan. 3, 2018

(30) Foreign Application Priority Data
Jan. 4, 2017 (CN) CN201710005799.7

(51) Int. Cl. B64C 39/02; G05D 1/00; G06K 9/46; G06T 7/70; G06T 11/60; G06T 5/20

(52) U.S. Cl. CPC B64C 39/024; G05D 1/0088; G05D 1/0094; G06K 9/4604; G06T 2207/30196; G06T 11/60; G06T 5/20; B64C 2201/127; B64C 2201/141; G06T 7/70

(57) ABSTRACT

An unmanned aerial vehicle interactive apparatus based on a deep learning posture estimation is provided. The apparatus (10) comprises: a shooting unit (11) for shooting an object video; a key frame extraction unit (12) for extracting a key frame image relating to an object from the shot object video; a posture estimation unit (13) for recognizing an object posture with respect to the key frame image based on an image recognition algorithm of a deep convolutional neural network; and an unmanned aerial vehicle operation control unit (14) for converting the recognized object posture into a control instruction so as to control the operation of the unmanned aerial vehicle. A human posture estimation is used to control the unmanned aerial vehicle conveniently. Moreover, in the key frame extraction and posture estimation, faster and more accurate results can be obtained by using the deep convolution neural network algorithm.

This application claims priority from Chinese patent application CN 201710005799.7, filed Jan. 4, 2017, which is incorporated herein by reference in its entirety.

### TECHNICAL FIELD

The present disclosure relates to the unmanned aerial vehicle interaction field, and in particular to an unmanned aerial vehicle interactive apparatus and method based on a deep learning posture estimation.

### BACKGROUND ART

An unmanned aerial vehicle has advantages such as low cost, small size and easy carriage, and has a broad application prospect in various fields, especially in the aerial shooting field. A study on an interaction between a human and the unmanned aerial vehicle has a good application value.

Most of traditional unmanned aerial vehicle interactive methods control the flight posture and operation of the unmanned aerial vehicle through a mobile phone or a remote control apparatus, so that the unmanned aerial vehicle ascends, descends, moves, and shoots. Most of such kind of control manners are complicated in operations, and require humans to control the flight posture of the unmanned aerial vehicle at any time, and it is very inconvenient to also consider the flight state of the unmanned aerial vehicle when completing simple tasks such as self-shooting.

A human body posture estimation is one key technique of a new generation of human-computer interaction. Relative to traditional contact-type operation manners such as a traditional mouse, keyboard, and remote control, the interactive mode of the human body posture estimation makes an operator get rid of a bondage of a remote control apparatus, has advantages such as a direct perception, an easy understanding and a simple operation, more accords with daily habits of humans, and has become a research hotspot in the field of human-computer interaction. With the development of unmanned aerial vehicle control technology, an interaction between humans and computers becomes more and more common, and use of a human body posture to control the unmanned aerial vehicle can more conveniently manipulate the unmanned aerial vehicle.

The artificial neural network was first put forward by W. S. McCulloch and W. Pitts in 1943. After more than 70 years of development, the artificial neural network has currently become a research hotspot in the field of artificial intelligence. The artificial neural network is composed of a large number of nodes that are connected with each other. Each node represents a specific output function, called an activation function. A connection between any two nodes represents a weighted value, called a weight, of a signal through the connection. Outputs of the network are different in accordance with different connection manners, activation functions and weighted values of the network.

The concept of deep learning was put forward by Hinton et al. in 2006. It superimposes a number of artificial neural networks on shallow layers together, uses a result obtained by learning on each layer as an input of the next layer, and adjusts the weights of all of the layers using a top-down supervised algorithm.

A convolutional neural network is a first supervised deep learning algorithm with a real multilayer structure. A deep convolutional neural network, which has characteristics of a high accuracy and a comparatively large set of training samples required, has been currently widely applied in various computer vision methods such as face recognition, gesture recognition and pedestrian detection, and can obtain a better result than the traditional methods.

Thus, an unmanned aerial vehicle interactive apparatus and method are desired, which perform a human body posture estimation using a deep learning algorithm of a convolutional neural network, and perform a human-computer interaction using the human body posture estimation so as to achieve the objective of controlling the operation of the unmanned aerial vehicle.

### SUMMARY OF THE INVENTION

In accordance with the discussions above, the objective of the invention lies in providing an unmanned aerial vehicle interactive apparatus and method, which can perform a human body posture estimation using a deep learning algorithm of a convolutional neural network, and perform a human-computer interaction using the human body posture estimation so as to control the operation of the unmanned aerial vehicle.

In order to achieve the objective above, according to a first aspect of the present invention, an unmanned aerial vehicle interactive apparatus based on a deep learning posture estimation is provided. The apparatus comprises: a shooting unit for shooting an object video; a key frame extraction unit for extracting a key frame image relating to an object from the shot object video; a posture estimation unit for recognizing an object posture with respect to the key frame image based on an image recognition algorithm of a deep convolutional neural network; and an unmanned aerial vehicle operation control unit for converting the recognized object posture into a control instruction so as to control the operation of the unmanned aerial vehicle.

Preferably, the unmanned aerial vehicle interactive apparatus of the present invention may further comprise: a preprocessing unit for performing an image transformation and filtering preprocess on the key frame image extracted by the key frame extraction unit, and inputting the preprocessed key frame image to the posture estimation unit to recognize the object posture.

Preferably, the key frame extraction unit may be further configured to: extract the key frame image including the object from the shot object video using an object detector based on the deep convolutional neural network algorithm.

Preferably, the object mentioned above is a human body.

Preferably, the posture estimation unit may further comprise: a human body key point positioning unit for acquiring human body key point position information in the key frame image using the image recognition algorithm of the deep convolutional neural network; and a posture determining unit for making the acquired human body key point position information correspond to a human body posture.

According to a second aspect of the present invention, an unmanned aerial vehicle interactive method based on a deep learning posture estimation is provided. The method comprises steps of: shooting an object video; extracting a key frame image relating to an object from the shot object video; recognizing an object posture with respect to the extracted key frame image based on an image recognition algorithm of a deep convolutional neural network; and converting the recognized object posture into a control instruction so as to control the operation of the unmanned aerial vehicle.

Preferably, the unmanned aerial vehicle interactive method of the present invention may further comprise: performing an image transformation and filtering preprocess on the extracted key frame image after extracting the key frame image relating to the object from the shot object video, and then recognizing the object posture with respect to the preprocessed key frame image.

Preferably, the step of extracting a key frame image relating to an object from the shot object video may further comprise: extracting the key frame image including the object from the shot object video using an object detection algorithm based on the deep convolutional neural network.

Preferably, the object mentioned above is a human body.

Preferably, the step of recognizing an object posture with respect to the extracted key frame image based on an image recognition algorithm of a deep convolutional neural network may further comprise: acquiring human body key point position information in the key frame image using the image recognition algorithm of the deep convolutional neural network; and making the acquired human body key point position information correspond to a human body posture.

The invention uses a human posture estimation to control the unmanned aerial vehicle, and can manipulate the unmanned aerial vehicle more conveniently. Moreover, in the key frame extraction and posture estimation, faster and more accurate results can be obtained by using the deep convolution neural network algorithm.

### BRIEF DESCRIPTION OF THE DRAWINGS

The invention is described below by referring to figures in combination with embodiments. In the figures:

FIG. 1 is a structural block diagram of an unmanned aerial vehicle interactive apparatus according to the present invention; and

FIG. 2 is a flow chart of an unmanned aerial vehicle interactive method according to the present invention.

### DETAILED DESCRIPTION OF THE EMBODIMENTS

The figures are only used for exemplary descriptions, and cannot be understood as limitations of the patent. The technical solutions of the invention are further described below by taking the figures and embodiments into consideration.

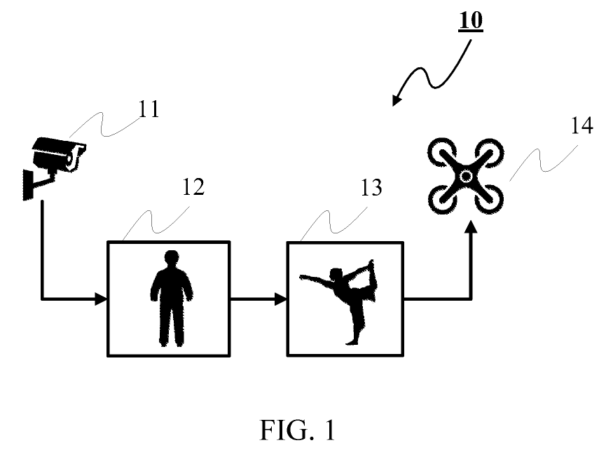

FIG. 1 is a structural schematic diagram of an unmanned aerial vehicle interactive apparatus according to the present invention.

As shown in FIG. 1, an unmanned aerial vehicle interactive apparatus 10 based on a deep learning posture estimation according to the present invention comprises: a shooting unit 11 for shooting an object video; a key frame extraction unit 12 for extracting a key frame image relating to an object from the shot object video; a posture estimation unit 13 for recognizing an object posture with respect to the key frame image based on an image recognition algorithm of a deep convolutional neural network; and an unmanned aerial vehicle operation control unit 14 for converting the recognized object posture into a control instruction so as to control the operation of the unmanned aerial vehicle.

In an embodiment according to the present invention, the shooting unit 11 is a camera on an unmanned aerial vehicle. The camera 11 on the unmanned aerial vehicle is responsible for providing continuous, stable, and real-time video signals. The camera 11 on the unmanned aerial vehicle captures an image. The image is projected onto a surface of an image sensor through an optical image generated by a lens, is converted into an electrical signal, is converted into a digital signal after being subjected to an analog to digital conversion, then is processed by a digital signal processing chip, and is finally output.

In the embodiment according to the present invention, the key frame extraction unit 12 is responsible for firstly detecting object information in an input video, selecting an object in the video using a rectangular frame, and extracting one image therein for output as a key frame. The core of the key frame extraction unit 12 is an object detection algorithm. The use of the object detection algorithm based on the deep convolutional neural network can rapidly and efficiently detect the object from the input video. That is to say, the key frame extraction unit 12 uses an object detector based on the deep convolutional neural network algorithm to extract the key frame image including the object from the object video shot by the camera 11 on the unmanned aerial vehicle.

Although not shown, the unmanned aerial vehicle interactive apparatus according to the present invention may further comprise a preprocessing unit for performing an image transformation and filtering preprocess on the key frame image extracted by the key frame extraction unit 12, and inputting the preprocessed key frame image to the posture estimation unit 13 to recognize the object posture.

In a preferred embodiment of the invention, the preprocessing unit may be a part (i.e., sub-module or sub-unit) of the key frame extraction unit 12. In other embodiments, the preprocessing unit may be also a part of the posture estimation unit 13. Those skilled in the art should understand that the preprocessing unit may be also independent of the key frame extraction unit 12 and the posture estimation unit 13.

The preprocessing unit is responsible for performing a transformation and filtering process on the image including the object (key frame image). Since conditions such as large noise, deformation and blurring may occur in the image shot by the camera 11 on the unmanned aerial vehicle, instability of a system may be resulted in. The preprocessing of the image shot by the unmanned aerial vehicle can efficiently achieve objectives such as noise reduction, deformation correction and blurring removal.

The object mentioned above may be a human body, a prosthesis (e.g., an artificial dummy, a man of straw or any other object that can imitate the human body), an animal body, or any other object that can use a posture to interact with the unmanned aerial vehicle to thereby control the operation of the unmanned aerial vehicle.

In the preferred embodiment according to the invention, the object is the human body. That is to say, the key frame extraction unit 12 is responsible for detecting human body information in an input video, selecting a person in the video using a rectangular frame, and extracting one image therein for output as a key frame. The use of a human body detection algorithm based on the deep convolutional neural network by the key frame extraction unit 12 can rapidly and efficiently detect the person from the input video. Optionally, the preprocessing unit is responsible for performing a transformation and filtering process on the image including the person (key frame image, i.e., pedestrian image).

In the embodiment according to the invention, the posture estimation unit 12 further comprises: a human body key point positioning unit for acquiring human body key point position information in the key frame image using the image recognition algorithm of the deep convolutional neural network; and a posture determining unit for making the acquired human body key point position information correspond to a human body posture.

The human body key point positioning unit uses the deep convolutional neural network algorithm to be responsible for firstly extracting a human body skeleton key point from the input pedestrian image, and the human body skeleton key point includes but is not limited to: a human body head, neck, left shoulder, right shoulder, left elbow, right elbow, left wrist, right wrist, left hip, right hip, left knee, right knee, left ankle, right ankle and so on. The output of the human body key point positioning unit is a two-dimensional coordinate of the human body skeleton key point above in the input image.

The posture determining unit is responsible for determining the two-dimensional coordinate of the human body skeleton key point above in the input image, comparing it with a preset human body posture, and making it correspond to a preset human body posture therein. The preset human body posture includes but is not limited to: the right hand swinging to the right, the left hand swinging to the left, the both hands horizontally pushing forwards, the both hands being taken back backwards, an unmanned aerial vehicle take-off instruction human body posture, an unmanned aerial vehicle landing instruction human body posture, an interaction starting instruction human body posture, an interaction ending instruction posture, an unmanned aerial vehicle shooting instruction human body posture and so on.

Those skilled in the art should understand that the specific number and specific patterns of the human body postures can depend on requirements for an unmanned aerial vehicle control. For example, when the unmanned aerial vehicle control is comparatively complicated, a comparatively large number of human body postures are required to perform different controls. In addition, when the human body postures are comparatively similar, a judgment error may be caused to thereby result in different control results, so the specific patterns of the human body postures should be ensured to have a certain difference so as not to be confused.

In the embodiment according to the invention, the unmanned aerial vehicle operation control unit 14 can be also called an unmanned aerial vehicle flight control module, and is responsible for making the human body posture obtained by the estimation by the human body posture estimation unit 13 correspond to an unmanned aerial vehicle flight control instruction, which includes but is not limited to: a right flight instruction, a left flight instruction, a forward instruction, a backward instruction, a take-off instruction, a landing instruction, an interaction starting instruction, an interaction ending instruction, a shooting instruction and so on. Moreover, for consideration of security and practicability in a control process, a pair of interaction starting and ending instructions of the unmanned aerial vehicle are set.

In FIG. 1, although the unmanned aerial vehicle operation control unit 14 is shown as an unmanned aerial vehicle graph, those skilled in the art should understand that the unmanned aerial vehicle operation control unit 14 herein can be a composite part of the unmanned aerial vehicle, and can be also one independent of the unmanned aerial vehicle, which controls the unmanned aerial vehicle through a wireless signal. Further, in other units in FIG. 1, in addition to that the shooting unit 11 should be generally carried on the unmanned aerial vehicle to shoot a video along with the flight of the unmanned aerial vehicle, the key frame extraction unit 12 and the posture estimation unit 13 can be either components on the unmanned aerial vehicle or ones independent of the unmanned aerial vehicle, which receive the shot video from the unmanned aerial vehicle through the wireless signal to thereby complete key frame extraction and posture estimation functions.

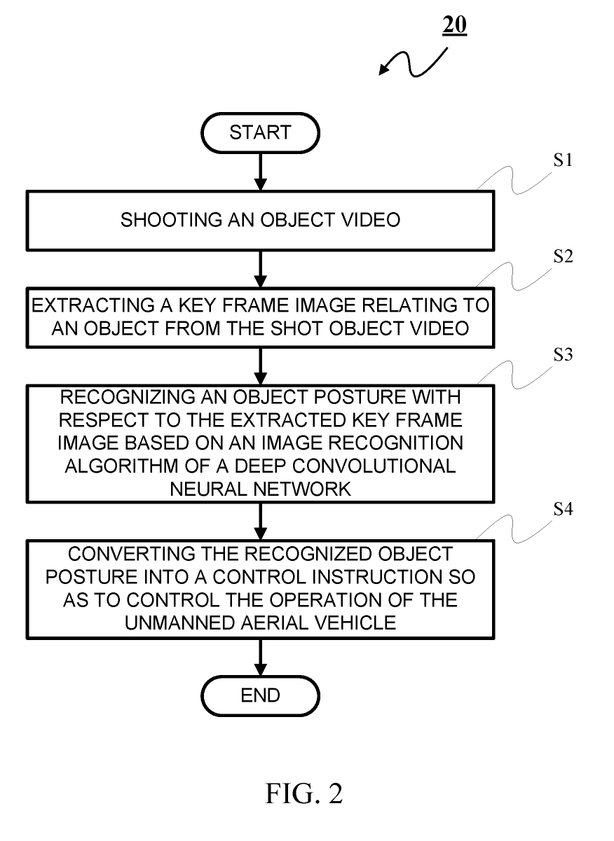

FIG. 2 is a flow chart of an unmanned aerial vehicle interactive method according to the present invention.

As shown in FIG. 2, an unmanned aerial vehicle interactive method 20 based on a deep learning posture estimation begins with Step S1, i.e., shooting an object video. To be specific, a human body video (a video including the human body) is shot through a camera on an unmanned aerial vehicle.

In Step S2, a key frame image relating to an object is extracted from the shot object video. To be specific, a key frame is extracted from the human body video and is preprocessed at a time interval.

In the preferred embodiment according to the invention, Step S2 further comprises: detecting and extracting an image key frame including a human body from a camera video using a human body detection algorithm based on a deep convolutional neural network.

In Step S3, an object posture is recognized with respect to the extracted key frame image based on an image recognition algorithm of a deep convolutional neural network. To be specific, the key frame is input to the human body posture estimation unit, and the corresponding human body posture is recognized using the image recognition algorithm based on the deep convolutional neural network.

In the preferred embodiment according to the invention, a preprocessing step may be further included between Step S2 and Step S3. To be specific, an image transformation and filtering preprocess is performed on the extracted key frame image after the key frame image relating to the object is extracted from the shot object video, and then the object posture is recognized with respect to the preprocessed key frame image.

The object mentioned herein can be a human body. As mentioned above, the object can be also a prosthesis, an animal body, etc.

The preprocessing includes process such as noise reduction, correction and motion blurring removal on the extracted human body image. As mentioned above, the preprocessing of the image shot by the unmanned aerial vehicle can efficiently achieve objects such as noise reduction, deformation correction and blurring removal.

Those skilled in the art should understand that although in the descriptions above, the preprocessing step is described as one between Step S2 and Step S3, the preprocessing step can be also considered as a composite part, i.e., sub-step, of Step S2 or Step S3. For example, it can be considered that the step of extracting the key frame, i.e., Step S2, is divided into two sub-steps of extracting the key frame and preprocessing the key frame.

In the preferred embodiment of the invention, in Step S3, the key frame is input to the human body posture estimation unit, and the corresponding human body posture is recognized using the image recognition algorithm based on the deep convolutional neural network. The specific method is as follows: the human body key point position information input in the image is positioned using the deep convolutional neural network algorithm, and the human body key point includes but is not limited to: a human body head, neck, left shoulder, right shoulder, left elbow, right elbow, left wrist, right wrist, left hip, right hip, left knee, right knee, left ankle, and right ankle. Then, the obtained human body key point position information is made to correspond to the human body posture, and the human body posture includes but is not limited to: the right hand swinging to the right, the left hand swinging to the left, the both hands horizontally pushing forwards, the both hands being taken back backwards and so on.

In Step S4, the recognized object posture is converted into a control instruction so as to control the operation of the unmanned aerial vehicle.

In the preferred embodiment according to the invention, in Step S4, the human body postures such as the right hand swinging to the right, the left hand swinging to the left, the both hands horizontally pushing forwards, and the both hands being taken back backward respectively correspond to an unmanned aerial vehicle right flight, left flight, forwardness and backwardness. The unmanned aerial vehicle control instruction includes but is not limited to: a right flight instruction, a left flight instruction, a forward instruction, a backward instruction, a take-off instruction, a landing instruction, an interaction starting instruction, an interaction ending instruction, a shooting instruction and so on.

In the preferred embodiment according to the invention, in Step S4, a pair of interaction starting and ending action instructions are set, the interaction starting instruction represents starting an action, and the interaction ending instruction represents ending an action.

After the completion of Step S4, the method 20 may end.

Especially, with respect to the deep convolutional neural network algorithm used in Step S2 in the preferred embodiment of the invention, a network input is a video frame, outputs of respective layers are sequentially computed from the bottom up via the network, the output of the final layer is a coordinate of a rectangular frame where the pedestrian is in a predicted video frame, a network weight should be obtained by pre-training, and a training method T1 includes:

T11. collecting in advance a video shot by the camera on the unmanned aerial vehicle as a candidate training set;

T12. artificially labeling the coordinate of the rectangular frame where the human body is in the video of the training set as labeled data of training;

T13. forwardly propagating the network, sequentially computing output values of respective layers of the deep convolutional neutral network from the bottom up, comparing the output value of the last layer with the labeled data, and performing computation to obtain a loss value;

T14. reversely propagating the network, sequentially computing losses and gradient directions of the respective layers from the top down based on weights and loss values of the respective layers, and updating the network weight in accordance with a gradient descent method; and

T15. cyclically performing T13 and T14 till the network converges, the finally obtained network weight being just used in the deep convolutional neural network for human body detection in S2.

Especially, with respect to the deep convolutional neural network algorithm used in Step S3, a network input is an image including a human body, outputs of respective layers are sequentially computed from the bottom up via the network, the final layer outputs coordinate predicted values of respective key points, a network weight should be obtained by pre-training, and a training method T2 includes:

T21. collecting in advance a human body picture set shot by the unmanned aerial vehicle as a candidate training set;

T22. artificially labeling the coordinate where the human body key point is in the image of the training set as labeled data of training;

T23. forwardly propagating the network, sequentially computing output values of respective layers of the deep convolutional neutral network from the bottom up, comparing the output value of the last layer with the labeled data, and performing computation to obtain a loss value;

T24. reversely propagating the network, sequentially computing losses and gradient directions of the respective layers from the top down based on weights and loss values of the respective layers, and updating the network weight in accordance with a gradient descent method; and

T25. cyclically performing T23 and T24 till the network converges, the finally obtained network weight being just used in the deep convolutional neural network for human body key point positioning in S3.

In the descriptions above, the present invention provides a novel unmanned aerial vehicle interactive apparatus and method, and features of its innovation not only include the technical features as recited in the claims, but also include the following contents:

1. Based on Deep Learning

In accordance with the descriptions above, in the technical solutions of the present invention, when the posture estimation is performed, the convolutional neural network is used to perform the deep learning, so that the human body posture can be rapidly and accurately recognized from a large amount of data to thereby perform interaction with the unmanned aerial vehicle. In addition, when the key frame is extracted, the convolutional neural network algorithm can be also used to thereby rapidly extract and recognize the key frame image including the human body.

2. Based on Human Body Posture Estimation

In accordance with the descriptions above, in the technical solutions of the invention, by determining the human body postures of the pedestrian in the video, the human body postures are made to correspond to different unmanned aerial vehicle operation instructions. To be more specific, the human body posture used in the invention is defined in accordance with the positioning of the human body key points including respective joints of the human body. That is to say, the human body posture recited in the invention is neither a simple gesture nor a simple motion trail or motion direction, but is a signal expression presented using the positions of the human body key points.

In practice, the problem of performing recognition using the gesture and performing human-computer interaction through the gesture lies in that the gesture is small in a picture shot by the unmanned aerial vehicle, and it is difficult to extract the picture in the video and perform fine recognition in the extracted picture, so the gesture can be only applied in specific occasions. Moreover, the number of the gestures is comparatively small, and the specific patterns are easily confused. In unmanned aerial vehicle interaction technology of the invention, a human body picture is easily extracted in the video, and a human body posture is easily recognized. Especially, since the human body posture depends on the positions of the human body key points, the specific number and specific patterns of the human body postures can be made to be defined according to actual requirements, and the application range is broader.

In addition, the problem of recognizing a motion trend and a motion direction to thereby perform the human-computer interaction lies in that information provided by such human-computer interaction, which is only the motion trend and direction, is too simple, so the unmanned aerial vehicle can be only made to perform operations related to the motion direction, e.g., tracking. In the unmanned aerial vehicle interaction technology of the present invention, since the human body posture depends on the positions of the human body key points, the specific number and specific patterns of the human body postures can be made to be defined according to actual requirements, so that the control of the unmanned aerial vehicle is more comprehensive and refined.

3. The Shooting Unit Requiring No Special Camera

In accordance with the descriptions above, the function of the shooting unit, i.e., camera, only lies in shooting a two-dimensional video, and the subsequent operations are all based on this two-dimensional video.

Some somatosensory games use special image collection devices, e.g., adopting a function of RGB-Depth, to thereby not only collect a two-dimensional image, but also induce the depth of the image, thereby providing the depth information of the object on the basis of the two-dimensional image, whereby human body posture recognition and action control are performed. There are also some applications in which binocular cameras are needed, so a binocular parallax principle is used on the basis of the two-dimensional image, which increases an effect of stereoscopic vision and also similarly increases depth information. However, in the present invention, it is only required to recognize the position information of the human body key points, i.e., the two-dimensional coordinates of the key points, and the depth information or steric information is not required. Thus, the present invention can use a conventional camera without reformation of the camera of the unmanned aerial vehicle, and the objective of interaction can be achieved just by directly using the video shot by the unmanned aerial vehicle.

4. Unmanned Aerial Vehicle Control Contents

In accordance with the descriptions above, an unmanned aerial vehicle interaction control performed based on the human body posture not only can control the flight of the unmanned aerial vehicle, but also can control other operations than the flight of the unmanned aerial vehicle. The other operations than the flight include but are not limited to: actions that can be achieved by the unmanned aerial vehicle such as shooting, firing and casting. Moreover, such operations can be combined with the flight operation, which all perform manipulation based on the recognition of the human body posture or the combination of the human body postures.

Thus, in addition to the independent claims and dependent claims in the Claims, those skilled in the art should also understand that a preferred implementation mode of the invention may contain the following technical features:

The object posture depends on position information of object key points. To be more specific, the human body posture depends on position information of human body key points. Preferably, the human body key points include a plurality of joints on the human body.

The shooting unit is a two-dimensional image shooting unit. That is, the object video shot thereby is a two-dimensional video.

The operation of the unmanned aerial vehicle includes a flight operation and/or non-flight operation of the unmanned aerial vehicle. The non-flight operation includes at least one of: shooting, firing and casting.

The unmanned aerial vehicle operation control unit can convert the combination of the recognized object postures into a control instruction so as to control the operation of the unmanned aerial vehicle. For example, the pedestrian can continuously make two or more postures, the posture estimation unit recognizes the two or more postures, and the unmanned aerial vehicle operation control unit converts the recognized two or more postures, as an object posture combination, into a corresponding control instruction so as to control the operation of the unmanned aerial vehicle.

The contents above have described the various embodiments and implementation situations of the invention, but the spirit and scope of the invention are not limited thereto. Those skilled in the art will be able to make more applications in accordance with the teaching of the invention, and these applications are all within the scope of the invention.

That is to say, the above embodiments of the invention are only examples given in order to clearly illustrate the invention, rather than limitations of the implementation modes of the invention. Those skilled in the art can further make other changes or modifications in different forms on the basis of the descriptions above. It is not required and impossible to exhaust all of the implementation modes herein. All amendments, substitutions, improvements and the like made within the spirit and principle of the invention should be included in the scope of protection of the claims of the invention.

1. An unmanned aerial vehicle interactive apparatus based on a deep learning posture estimation, comprising:
a shooting unit for shooting an object video;
a key frame extraction unit for extracting a key frame image relating to an object from the shot object video;
a posture estimation unit for recognizing an object posture with respect to the key frame image based on an image recognition algorithm of a deep convolutional neural network; and
an unmanned aerial vehicle operation control unit for converting the recognized object posture into a control instruction so as to control the operation of the unmanned aerial vehicle.

2. The unmanned aerial vehicle interactive apparatus according to claim 1, further comprising:
a preprocessing unit for performing an image transformation and filtering preprocess on the key frame image extracted by the key frame extraction unit, and inputting the preprocessed key frame image to the posture estimation unit to recognize the object posture.

3. The unmanned aerial vehicle interactive apparatus according to claim 1, wherein the key frame extraction unit is further configured to:
extract the key frame image including the object from the shot object video using an object detector based on the deep convolutional neural network algorithm.

4. The unmanned aerial vehicle interactive apparatus according to claim 1, wherein the object is a human body.

5. The unmanned aerial vehicle interactive apparatus according to claim 4, wherein the posture estimation unit further comprises:
a human body key point positioning unit for acquiring human body key point position information in the key frame image using the image recognition algorithm of the deep convolutional neural network; and
a posture determining unit for making the acquired human body key point position information correspond to a human body posture.

6. An unmanned aerial vehicle interactive method based on a deep learning posture estimation, comprising steps of:
shooting an object video;
extracting a key frame image relating to an object from the shot object video;
recognizing an object posture with respect to the extracted key frame image based on an image recognition algorithm of a deep convolutional neural network; and
converting the recognized object posture into a control instruction so as to control the operation of the unmanned aerial vehicle.

7. The unmanned aerial vehicle interactive method according to claim 6, further comprising:
performing an image transformation and filtering preprocess on the extracted key frame image after extracting the key frame image relating to the object from the shot object video, and then recognizing the object posture with respect to the preprocessed key frame image.

8. The unmanned aerial vehicle interactive method according to claim 6, wherein the step of extracting a key frame image relating to an object from the shot object video further comprises:
extracting the key frame image including the object from the shot object video using an object detection algorithm based on the deep convolutional neural network.

9. The unmanned aerial vehicle interactive method according to claim 6, wherein the object is a human body.

10. The unmanned aerial vehicle interactive method according to claim 9, wherein the step of recognizing an object posture with respect to the extracted key frame image based on an image recognition algorithm of a deep convolutional neural network further comprises:
acquiring human body key point position information in the key frame image using the image recognition algorithm of the deep convolutional neural network; and
making the acquired human body key point position information correspond to a human body posture.
